(19) United States
(12) Patent Application Publication
(10) Pub. No.: US 2024/0072394 A1
(43) Pub. Date: Feb. 29, 2024

(54) BATTERY

(71) Applicant: MURATA MANUFACTURING CO., LTD., Kyoto (JP)

(72) Inventor: Teppei AKIYOSHI, Kyoto (JP)

(21) Appl. No.: 18/238,691

(22) Filed: Aug. 28, 2023

(30) Foreign Application Priority Data
Aug. 29, 2022 (JP) 2022-135922

(51) Int. Cl. H01M 50/562; H01M 10/0587; H01M 50/119; H01M 50/188; H01M 50/193; H01M 50/538

(52) U.S. Cl. CPC H01M 50/562; H01M 10/0587; H01M 50/119; H01M 50/188; H01M 50/193; H01M 50/538

(57) ABSTRACT

A battery is provided and includes: a battery element body including a positive electrode, a negative electrode, and a separator disposed between the positive electrode and the negative electrode; a housing that houses the battery element body and is provided with an opening; and a positive electrode terminal that is disposed outside the housing, is joined to an edge portion of the opening with an adhesive layer interposed therebetween in a state of covering the opening, and includes aluminum or an aluminum alloy. The housing is electrically connected to the negative electrode of the battery element body. In the positive electrode terminal, a first portion overlapping the opening when viewed from a direction intersecting the edge portion of the opening is electrically connected to the positive electrode of the battery element body, and an anodic oxide coating is provided at a portion of the positive electrode terminal facing the adhesive layer.

### CROSS REFERENCE TO RELATED APPLICATION

The present application claims priority to Japanese patent application no. 2022-135922, filed on Aug. 29, 2022, the entire contents of which are incorporated herein by reference.

### BACKGROUND

The present application relates to a battery.

A secondary battery is described and including a rivet serving as a positive electrode terminal and a gasket being secured by crimping the rivet. Specifically, the rivet (positive electrode terminal) includes a plate portion and a pin protruding from the plate portion. After the pin is inserted into the through hole of the gasket, the rivet is crimped onto the gasket by deformation due to crushing the tip portion of the pin. The rivet, the gasket, and the battery element body are housed in the housing.

An another secondary battery is described and includes a battery element body and an exterior case that houses the battery element body. The negative electrode body of the battery element body is connected to the exterior case. An insertion hole is provided through the exterior case, and a lead body connected to the positive electrode body of the battery element body is inserted into the insertion hole. The flat-plate electrode terminal disposed outside the exterior case and covering the insertion hole is connected to the lead body. The flat-plate electrode terminal and the outer surface of the exterior case are joined with a seal member interposed therebetween.

The another secondary battery described includes a heat seal type battery case and an aluminum terminal protruding from the battery case, and an alumite layer is provided on the surface of the aluminum terminal. The alumite layer improves adhesion between the inner surface film of the battery case and the terminal.

A secondary battery is described and having a bipolar electrode. In the bipolar electrode, a positive electrode active material layer is provided on one surface of a current collector, and a negative electrode active material layer is provided on the other surface of the current collector. The battery element body has a plurality of bipolar electrodes stacked vertically.

### SUMMARY

The present application relates to a battery.

In recent years, there is a demand for further miniaturization of batteries.

The present application, in an embodiment, relates to providing a more miniaturized battery.

A battery according to an embodiment of the present application includes: a battery element body including a positive electrode, a negative electrode, and a separator disposed between the positive electrode and the negative electrode; a housing that houses the battery element body and has an opening; a positive electrode terminal that covers the opening and is disposed outside the housing; and an adhesive layer that joins the housing and the positive electrode terminal, in which the positive electrode and the positive electrode terminal are electrically connected, and an anodic oxide coating is provided on a portion of the positive electrode terminal facing the adhesive layer.

According to the present application, it is possible to provide a more miniaturized battery in an embodiment.

### BRIEF DESCRIPTION OF THE FIGURES

FIG. 1 is a schematic view illustrating a section of a battery according to an embodiment;

FIG. 2 is a schematic exploded view of the battery of FIG. 1;

FIG. 3 is a schematic view in which a section of a part of FIG. 2 is enlarged;

FIG. 4 is a rear view of the positive electrode terminal according to the first embodiment as viewed from the back surface side;

FIG. 5 is a schematic view illustrating a section of a battery according to an embodiment;

FIG. 6 is a schematic view in which a part of FIG. 5 is enlarged;

FIG. 7 is a sectional view showing a positive electrode terminal according to an embodiment; and

FIG. 8 is a sectional view showing a positive electrode terminal according to an embodiment.

### DETAILED DESCRIPTION

Hereinafter, one or more embodiments will be described in further detail including with reference to the drawings. Note that the present application is not limited by the embodiments. Each embodiment is illustrative, and replacement and combination of a part of configurations shown in the different embodiments can be performed. In a second embodiment and subsequent embodiments, matters common to those of a first embodiment will not be described, and only differences will be described. In particular, a similar effect by a similar structure will not be sequentially referred to for each embodiment.

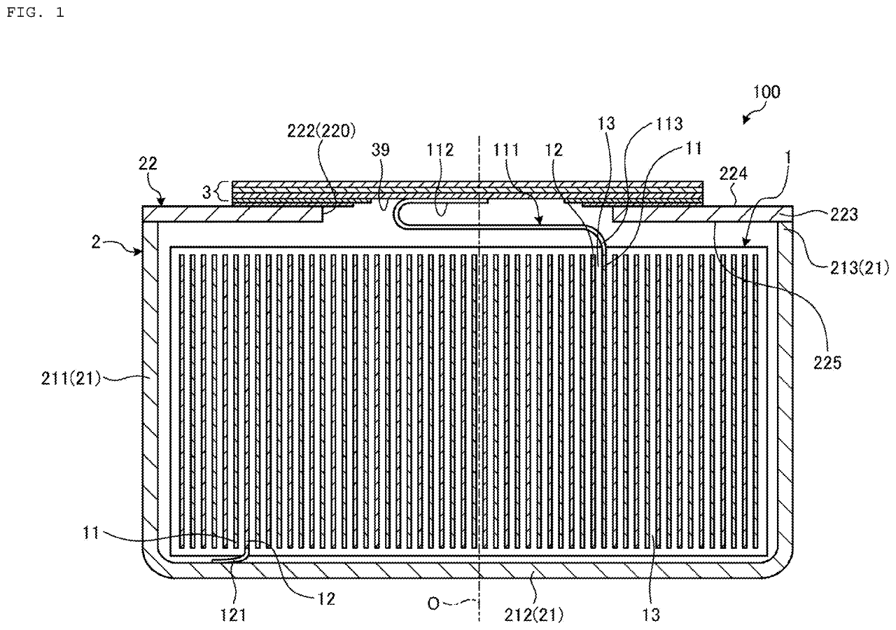

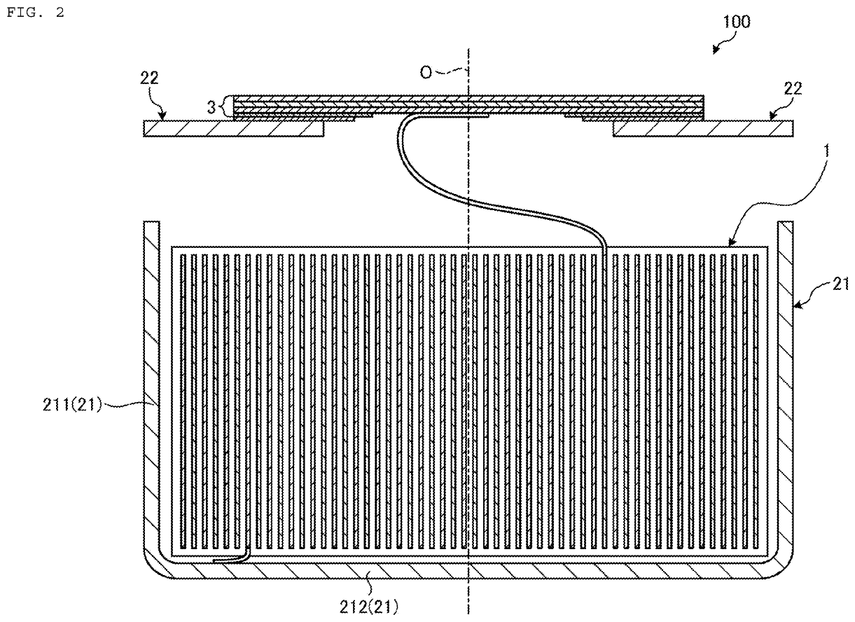

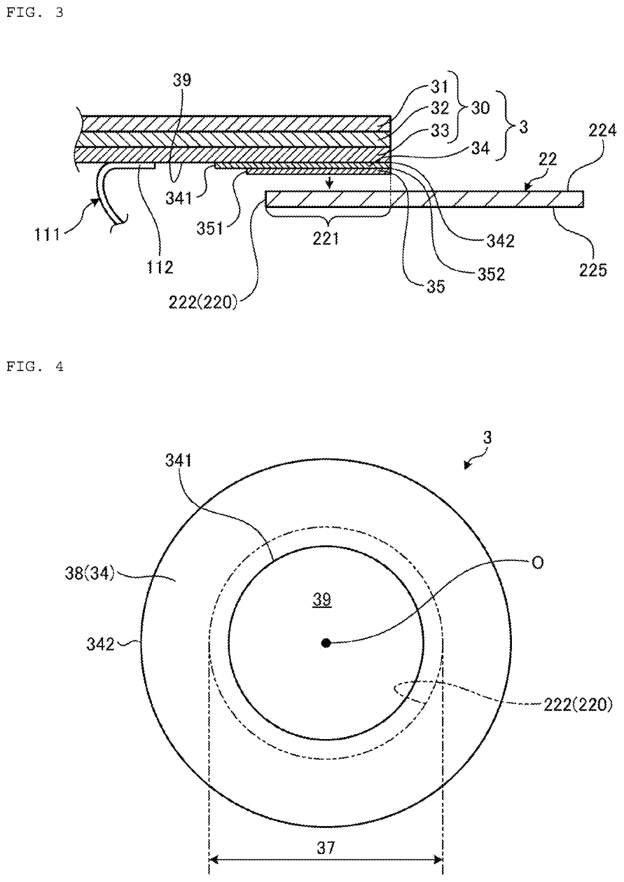

First, a battery according to a first embodiment will be described. FIG. 1 is a schematic view illustrating a section of a battery according to the first embodiment. FIG. 2 is a schematic exploded view of the battery of FIG. 1. FIG. 3 is a schematic view in which a section of a part of FIG. 2 is enlarged. FIG. 4 is a rear view of the positive electrode terminal according to the first embodiment as viewed from the back surface side.

The battery 100 shown in each FIGS. 1 and 2 is, for example, a chemical battery including a secondary battery. As the secondary battery, for example, a lithium ion secondary battery can be applied. However, the battery according to the present application is not limited to the secondary battery, and various other batteries can be applied.

As shown in FIGS. 1 and 2, a battery 100 includes a battery element body 1, a housing 2, and a positive electrode terminal 3.

As shown in FIG. 1, the battery element body 1 includes a positive electrode 11, a negative electrode 12, and a separator 13. Specifically, the separator 13 is interposed between the positive electrode 11 and the negative electrode 12. That is, in the battery element body 1, the positive electrode 11, the separator 13, and the negative electrode 12 are arranged in this order.

The battery element body 1 may be a wound body in which the positive electrode 11 and the negative electrode 12 are stacked on each other with the separator 13 interposed therebetween, and the positive electrode 11, the negative electrode 12, and the separator 13 are wound. Also, the battery element body 1 may be a stacked body in which the positive electrode 11 and the negative electrode 12 are stacked on each other with the separator 13 interposed therebetween.

The positive electrode 11 includes a positive electrode current collector and a positive electrode active material layer. The positive electrode current collector is a conductive support that supports the positive electrode active material layer, and has a pair of surfaces on which the positive electrode active material layer is provided. The positive electrode current collector includes a conductive material such as a metal material, and the metal material is aluminum or the like. The positive electrode active material layer may be provided on both surfaces or one surface of the positive electrode current collector.

The positive electrode active material layer contains any one kind or two or more kinds among positive electrode active materials capable of occluding and releasing lithium. The positive electrode active material layer may further contain any one kind or two or more kinds among materials such as a positive electrode binder and a positive electrode conductive agent. A method for forming the positive electrode active material layer is not particularly limited, but is specifically a coating method or the like.

The positive electrode active material contains a lithium compound. This is because a high energy density can be obtained. This lithium compound is a compound containing lithium as a constituent element, and more specifically, a compound containing one kind or two or more kinds of transition metal elements as constituent elements together with lithium. However, the lithium compound may further contain any one kind or two or more kinds among other elements other than lithium or the transition metal element.

The type of the lithium compound is not particularly limited, and specific examples thereof include an oxide, a phosphoric acid compound, a silicic acid compound, and a boric acid compound. Specific examples of the oxide include LiNiO₂, LiCoO₂, and LiMn₂O₄. Specific examples of the phosphoric acid compound include LiFePO₄ and LiMnPO₄.

The positive electrode binder contains any one kind or two or more kinds among synthetic rubber, a polymer compound, and the like. The synthetic rubber is styrene-butadiene-based rubber or the like, and the polymer compound is polyvinylidene fluoride or the like. The positive electrode conductive agent contains any one kind or two or more kinds among conductive materials such as carbon materials, and the carbon material is graphite, carbon black, acetylene black, Ketjen black, or the like. However, the conductive material may be a metal material, a polymer compound, or the like.

The negative electrode 12 includes a negative electrode current collector and a negative electrode active material layer. The negative electrode current collector is a conductive support that supports the negative electrode active material layer, and has a pair of surfaces on which the negative electrode active material layer is provided. The negative electrode current collector includes a conductive material such as a metal material, and the metal material is copper or the like. The negative electrode active material layer may be provided on both surfaces or one surface of the negative electrode current collector.

The negative electrode active material layer contains any one kind or two or more kinds among negative electrode active materials capable of occluding and releasing lithium. The negative electrode active material layer may further contain any one kind or two or more kinds among materials such as a negative electrode binder and a negative electrode conductive agent. Details regarding each of the negative electrode binder and the negative electrode conductive agent are the same as the details regarding each of the positive electrode binder and the positive electrode conductive agent. The method for forming the negative electrode active material layer is not particularly limited, but is specifically any one kind or two or more kinds among a coating method, a gas phase method, a liquid phase method, a thermal spraying method, a firing method (sintering method), and the like.

The negative electrode active material contains one or both of a carbon material and a metal-based material, and the like. This is because a high energy density can be obtained. Examples of the carbon material include graphitizable carbon, non-graphitizable carbon, and graphite (natural graphite and artificial graphite). The metal-based material is a material containing any one kind or two or more kinds among metal elements and metalloid elements capable of forming an alloy with lithium as constituent elements, and specific examples of the metal element and the metalloid element include one or both of silicon and tin. However, the metal-based material may be a simple substance, an alloy, a compound, a mixture of two or more thereof, or a material containing two or more phases thereof. Specific examples of the metal-based material include TiSi₂ and SiOₓ (0≤x≤2 or 0.2≤x≤1.4).

The separator 13 is an insulating porous film interposed between the positive electrode 11 and the negative electrode 12, and allows lithium ions to pass therethrough while preventing contact (short circuit) between the positive electrode 11 and the negative electrode 12. The separator 13 includes a polymer compound such as polyethylene.

Each of the positive electrode 11, the negative electrode 12, and the separator 13 is impregnated with the electrolytic solution, and the electrolytic solution contains a solvent and an electrolyte salt. The solvent contains any one kind or two or more kinds among non-aqueous solvents (organic solvents) such as carbonic acid ester compounds, carboxylic acid ester compounds, and lactone compounds, and the electrolytic solution containing the non-aqueous solvent is a so-called non-aqueous electrolytic solution. The electrolyte salt contains any one kind or two or more kinds among light metal salts such as lithium salts.

As shown in FIG. 1, the housing 2 has a housing main body 21 and a lid 22, and houses the battery element body 1. The housing 2 includes Fe, Ni, stainless steel, Cu, or a material obtained by subjecting these to Ni plating. The housing main body 21 has a bottom portion 212 and a side portion 211. The bottom portion 212 has a circular shape centered on the center O, and the side portion 211 has a cylindrical shape extending along the circumferential direction around the axis of the center O. The side portion 211 extends upward from an end portion of the bottom portion 212. The housing main body 21 has a U-shaped section and has an open upper side. A lid 22 is joined to the upper end portion 213 of the side portion 211. Specifically, the outer peripheral end portion 223 of the lid 22 is joined to the upper end portion 213 of the side portion 211. The lid 22 has an annular shape centered on the center O. The lid 22 is provided with a circular opening 220 at the center. The opening 220 faces the inner side (inner peripheral side) of the inner wall 222. The bottom portion 212 of the housing 2 is connected to the negative electrode 12 of the battery element body 1 by the wiring 121. The housing main body 21 and the lid 22 may be integrally molded.

As shown in FIG. 1, the positive electrode terminal 3 is joined to the upper side of the lid 22. The positive electrode terminal 3 is disposed outside the housing 2, and is joined to the lid 22 in a state of covering the opening 220 of the lid 22. With such a configuration, the opening 220 is sealed by the positive electrode terminal 3. The positive electrode terminal 3 will be described later in detail.

As shown in FIG. 3, the positive electrode terminal 3 includes a clad material 30 and an anodic oxide coating 34. The clad material 30 includes a nickel material 31, a stainless steel material 32, and an aluminum material 33. Specifically, the stainless steel material 32 is joined to the back side (lower side) of the nickel material 31, and the aluminum material 33 is joined to the back side (lower side) of the stainless steel material 32. An anodic oxide coating 34 is formed on the back side (lower side) of the aluminum material 33. The anodic oxide coating 34 is also referred to as a so-called alumite layer. The average thickness of the anodic oxide coating 34 is 2 μm or more and 100 μm or less, and more preferably 10 μm or more and 50 μm or less. The Vickers hardness of the anodic oxide coating 34 is, for example, HV300 or more.

An adhesive layer 35 is provided on the back side (lower side) of the anodic oxide coating 34. The adhesive layer 35 includes a polyolefin-based resin. The lid 22 has an upper surface 224 and a lower back surface 225. The surface 224 of the lid 22 and the anodic oxide coating 34 are joined with an adhesive layer 35 interposed therebetween. Specifically, the anodic oxide coating 34 is joined to the edge portion 221 of the opening 220 on the surface 224 of the lid 22 with the adhesive layer 35 interposed therebetween. The adhesive layer 35 is provided in a region from the end 351 on the inner peripheral side to the end 352 on the outer peripheral side. Here, the adhesive layer 35 is provided on the back side (lower side) of the anodic oxide coating 34, but may be provided on the edge portion 221 of the opening 220. The edge portion 221 of the opening 220 refers to a region from the inner wall 222 to a portion corresponding to the outer peripheral end of the positive electrode terminal 3 in the portion of the lid 22. The average distance between the anodic oxide coating 34 in the positive electrode terminal 3 and the edge portion 221 of the opening 220 in the housing 2 is more than 0 μm and 30 μm or less. The average distance is, for example, an average value of measured values obtained by measuring distances at a total of four locations which are two positions of about 20% and two positions of about 80% from the inner wall 222 of the edge portion 221 in one section randomly selected.

As shown in FIG. 4, the positive electrode terminal 3 has a circular shape centered on the center O. The formation region 38 where the anodic oxide coating 34 is provided is annularly arranged on the outer peripheral side of the positive electrode terminal 3. The formation region 38 has an inner peripheral end 341 and an outer peripheral end 342. On the inner peripheral side of the inner peripheral end 341 of the formation region 38, a circular non-formation region 39 where the anodic oxide coating 34 is not provided is arranged. As shown in FIG. 4, when the inner wall 222 of the lid 22 is indicated by a dot-dot-dash line, a region inside the dot-dot-dash line is referred to as a first portion 37. The first portion 37 is a portion of the positive electrode terminal 3 which overlaps with the opening 220 when viewed in the vertical direction. The first portion 37 includes an anodic oxide coating 34 non-formation region 39.

In addition, since the aluminum material 33 is exposed in the non-formation region 39, as illustrated in FIGS. 1 and 3, the aluminum material 33 in the non-formation region 39 and the positive electrode 11 of the battery element body 1 are electrically connected. For example, the end portion 112 of the wiring 111 electrically connected to the positive electrode 11 of the battery element body 1 is connected to the aluminum material 33 of the non-formation region 39. As illustrated in FIGS. 1 and 2, the end portion 113 of the wiring 111 is connected to the positive electrode 11 of the battery element body 1. The wiring 111 is a connection wiring for the positive electrode 11 that connects the positive electrode 11 to the positive electrode terminal 3. The wiring 121 is a connection wiring for the negative electrode 12 that connects the negative electrode 12 to the housing 2. The wiring may be attached to the battery element body 1 or may be drawn out from the battery element body 1.

As described above, the battery 100 according to the first embodiment includes: the battery element body 1 including the positive electrode 11, the negative electrode 12, and the separator 13 disposed between the positive electrode 11 and the negative electrode 12; the housing 2 that houses the battery element body 1 and is provided with the opening 220; and the positive electrode terminal 3 that is disposed outside the housing 2, is joined to the edge portion 221 of the opening 220 with the adhesive layer 35 interposed therebetween in a state of covering the edge portion 221, and includes aluminum or an aluminum alloy. The housing 2 is electrically connected to the negative electrode 12 of the battery element body 1, and the positive electrode terminal 3 is electrically connected to the positive electrode 11 of the battery element body 1. An anodic oxide coating 34 is formed on a portion of the positive electrode terminal 3 facing the adhesive layer 35.

The lid 22 which is a part of the housing 2 is provided with an opening 220, and the opening 220 is sealed with the positive electrode terminal 3. The positive electrode terminal 3 is provided with an anodic oxide coating 34. Since the anodic oxide coating 34 has high insulating properties and high strength, it is possible to maintain insulation between the positive electrode terminal 3 and the lid 22 also in a case where the thickness of the adhesive layer 35 is reduced. As described above, according to the present embodiment, it is possible to miniaturize the battery 100 by reducing the thickness of the adhesive layer 35 as compared with the case where the positive electrode terminal 3 is not provided with the anodic oxide coating 34. Since the positive electrode terminal 3 is provided with the anodic oxide coating 34, it is not necessary to newly provide an insulating layer or the like, and the battery 100 can be miniaturized. The thickness of the adhesive layer 35 is, for example, 5 μm or more and 200 μm or less, and more preferably 10 μm or more and 150 μm or less.

The thickness of the anodic oxide coating 34 is 2 μm or more and 100 μm or less, and more preferably 10 μm or more and 50 μm or less.

When the thickness of the anodic oxide coating 34 is less than 2 μm, there is a possibility that insulation between the positive electrode terminal 3 and the lid 22 cannot be secured. When the thickness of the anodic oxide coating 34 is more than 100 μm, the anodic oxide coating 34 is easily broken, and the time for the anodic oxidation treatment is long, whereby the positive electrode terminal 3 may be deformed. For this reason, the thickness of the anodic oxide coating 34 is preferably 2 μm or more and 100 μm or less. The thickness of the anodic oxide coating 34 is preferably, for example, ⅓ of the thickness of the positive electrode terminal 3. An oxide film is formed on the surface of aluminum by natural oxidation, but the thickness of the oxide film is, for example, 2 nm (nanometer), and does not become 2 μm or more, which is the thickness of the anodic oxide coating 34.

The positive electrode terminal 3 includes a material such as aluminum, an aluminum alloy, or a clad material containing aluminum. The aluminum and the aluminum alloy are not particularly limited, and examples thereof include A1000, A2000, A3000, A4000, A5000, A6000, and A7000 series. Note that materials of A3000, A1000, A5000, and A6000 series are preferable because the film hardness is HV450 or more. The positive electrode terminal 3 preferably includes an aluminum alloy containing 93% by mass or more of Al and less than 6% by mass of impurities. Examples of the impurities include less than 1% by mass of Fe, less than 1% by mass of Cu, less than 1% by mass of Zn, less than 1% by mass of Mn, and less than 2% by mass of Si.

When the amount of impurities other than Al is large, the impurities are ionized, whereby it is difficult to form the anodic oxide coating 34. Thus, by suppressing the contents of Fe, Cu, Zn, Mn, and Si as impurities within the above ranges, the anodic oxide coating 34 can be smoothly formed on the positive electrode terminal 3.

The average distance between the anodic oxide coating 34 in the positive electrode terminal 3 and the edge portion 221 of the opening 220 in the housing 2 is more than 0 μm and 30 μm or less.

An adhesive layer 35 is provided between the anodic oxide coating 34 and the edge portion 221 of the opening 220. Thus, when the average distance is more than 0 μm and 30 μm or less, volatilization of the electrolytic solution from the inside to the outside of the housing can be suppressed, and infiltration of the liquid from the outside to the inside of the housing can be suppressed, as a result of which the life of the battery 100 can be lengthened.

When the thickness of the adhesive layer 35 is measured at a plurality of locations, there are some locations where the adhesive layer 35 is not provided, and the anodic oxide coating 34 and the edge portion 221 of the opening 220 are in contact with each other. At that location, the distance between the anodic oxide coating 34 and the edge portion 221 of the opening 220 is 0 μm. However, also in this case, since the adhesive layer 35 is provided at other locations, the average thickness of the plurality of locations in the adhesive layer 35 is not 0 μm. Thus, the average distance is larger than 0 μm. When the average distance is more than 30 μm, the size of the battery 100 becomes large, which is not preferable.

The housing 2 includes Fe, Ni, stainless steel, Cu, or a material obtained by subjecting these to Ni plating.

In this way, since the strength of the housing 2 can be increased, the thickness of the housing 2 can be reduced. Thus, the battery 100 can be miniaturized. Also in the case where the outer shape of the housing 2 is made the same size, the internal space of the housing 2 can be enlarged, and the battery capacity can be increased by enlarging the battery element body 1.

The Vickers hardness of the anodic oxide coating 34 is HV300 or more.

When the Vickers hardness of the anodic oxide coating 34 is high, the strength of the anodic oxide coating 34 is high. Thus, when a force is applied to the anodic oxide coating 34, for example, at the time of assembling the battery 100, the anodic oxide coating 34 is less likely to be damaged, as a result of which the yield of the battery 100 can be improved. Also, for example, in a case where the battery 100 as a product receives impact from the outside during use, the anodic oxide coating 34 is not damaged, and short circuit of the battery 100 can be avoided.

The Vickers hardness of the hard alumite layer is, for example, HV400, and the Vickers hardness of the standard anodic oxide coating 34 is, for example, HV200. Thus, as the anodic oxide coating 34, for example, a hard alumite layer is preferable.

The adhesive layer 35 includes a polyolefin-based resin.

Also in a case where the adhesive layer 35 of a polyolefin-based resin is used for a non-aqueous solvent-based battery such as a lithium ion secondary battery, deterioration of the adhesive layer 35 due to an electrolytic solution is small, and leakage of the electrolytic solution can be prevented for a long period of time. In addition, for example, the adhesive layer 35 softens and peels off at the time when the lithium ion secondary battery is in abnormal conditions, whereby an increase in internal pressure can be suppressed, and the influence of the abnormality of the battery 100 on the surroundings can be reduced.

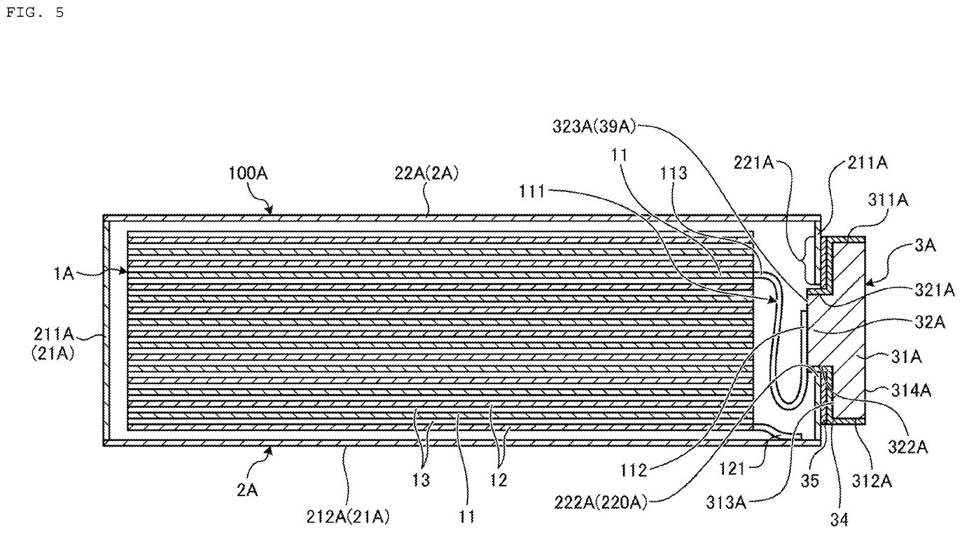

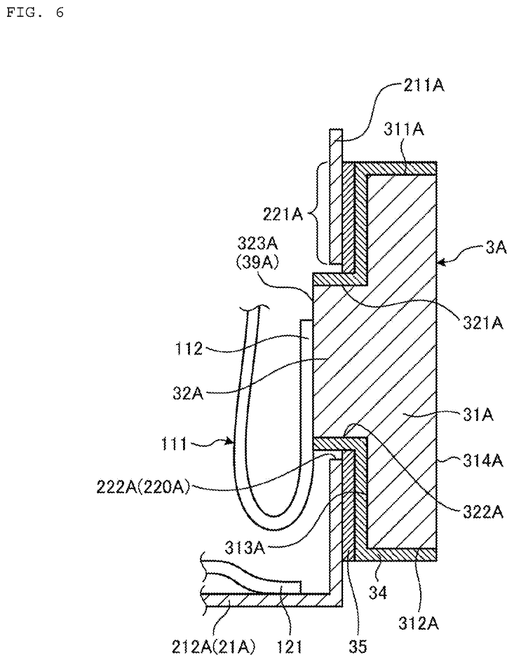

Next, a battery according to a second embodiment will be described. FIG. 5 is a schematic view illustrating a section of a battery according to the second embodiment. FIG. 6 is a schematic view in which a part of FIG. 5 is enlarged. The battery 100A includes a battery element body 1A, a housing 2A, and a positive electrode terminal 3A.

As shown in FIG. 5, the battery element body 1A includes a positive electrode 11, a negative electrode 12, and a separator 13. In the battery element body 1, the positive electrode 11, the separator 13, and the negative electrode 12 are arranged in this order in the vertical direction.

As shown in FIG. 5, the housing 2A has a housing main body 21A and a lid 22A, and houses the battery element body 1A. As the material of the housing 2A, for example, stainless steel or the like can be applied. The housing main body 21A has a bottom portion 212A and a side portion 211A. The housing main body 21A has a U-shaped section and has an open upper side. The lid 22A is joined to the upper end portion of the side portion 211A. The side portion 211A is provided with an opening 220A, and the positive electrode terminal 3A is disposed outside the housing 2A and is joined to the side portion 211A in a state of covering the opening 220A of the side portion 211A. With such a configuration, the opening 220A is sealed with the positive electrode terminal 3A.

As shown in FIG. 5 and FIG. 6, the positive electrode terminal 3A includes a main body portion 31A, a protrusion 32A, and an anodic oxide coating 34. The positive electrode terminal 3A has a T-shaped section. The main body portion 31A and the protrusion 32A are made of aluminum or an aluminum alloy.

The main body portion 31A extends in the vertical direction. The main body portion 31A has an upper surface 311A, a lower surface 312A, a front surface 313A, and a rear surface 314A. The upper surface 311A and the lower surface 312A extend substantially in parallel. The front surface 313A and the rear surface 314A extend substantially in parallel. The protrusion 32A protrudes laterally from the vertical center portion of the main body portion 31A. The protrusion 32A has an upper surface 321A, a lower surface 322A, and a front surface 323A. The upper surface 321A and the lower surface 322A extend substantially in parallel. The protrusion 32A is inserted into the opening 220A.

The anodic oxide coating 34 is provided on the main body portion 31A and the protrusion 32A. Specifically, anodic oxide coating 34 is provided on upper surface 311A, lower surface 312A, and front surface 313A of main body portion 31A, and upper surface 321A and lower surface 322A of protrusion 32A. In the second embodiment, the front surface 323A of the protrusion 32A is the anodic oxide coating 34 non-formation region 39A. The edge portion 221A of the opening 220A refers to a region from the inner wall 222A of the side portion 211A to a portion corresponding to the upper surface 311A of the positive electrode terminal 3A, and a region from the inner wall 222A of the side portion 211A to a portion corresponding to the lower surface 312A of the positive electrode terminal 3A. The end portion 112 of the wiring 111 is connected to the front surface 323A of the protrusion 32A which is the non-formation region 39A.

The front surface 313A of the main body portion 31A is joined to the side portion 211A with the adhesive layer 35 interposed therebetween. Specifically, the front surface 313A of the main body portion 31A is joined to the edge portion 221A of the opening 220A with the adhesive layer 35 interposed therebetween. The adhesive layer 35 includes an epoxy resin.

As described above, also in the battery 100A according to the second embodiment, similarly to the battery 100 according to the first embodiment, the anodic oxide coating 34 is formed on a portion of the positive electrode terminal 3A facing the adhesive layer 35. Thus, it is possible to miniaturize the battery 100A by reducing the thickness of the adhesive layer 35 as compared with the case where the positive electrode terminal 3A is not provided with the anodic oxide coating 34.

The average distance between the anodic oxide coating 34 in the positive electrode terminal 3A and the edge portion 221A of the opening 220A in the housing 2A is more than 0 μm and 30 μm or less.

When the average distance is more than 0 μm and 30 μm or less as described above, volatilization of the electrolytic solution from the inside to the outside of the housing can be suppressed, and infiltration of the liquid from the outside to the inside of the housing can be suppressed, as a result of which the life of the battery 100A can be lengthened.

The adhesive layer 35 includes an epoxy resin.

The adhesive layer 35 including an epoxy resin can withstand high temperatures, and effectively suppresses volatilization of the electrolytic solution, as a result of which prolonging the life of the battery 100A can be realized.

As the battery 100 according to the first embodiment and the battery 100A according to the second embodiment, for example, a monopolar lithium ion battery can be applied. As a result, it is possible to supply a high battery capacity density required for electronic devices such as mobile devices, wearable devices, and IoT devices at 3 V or more and 4 V or less, which is an optimum voltage for electronics.

Next, a first modification will be described. FIG. 7 is a sectional view showing a positive electrode terminal according to the first modification. In the positive electrode terminal 3B according to the first modification, the anodic oxide coating 34 is provided only on the front surface 313A of the main body portion 31A.

With such a configuration, the anodic oxide coating 34 is formed only on a portion where the anodic oxide coating 34 is most required in the positive electrode terminal 3B, and hence, a manufacturing cost can be reduced.

### [Second Modification]

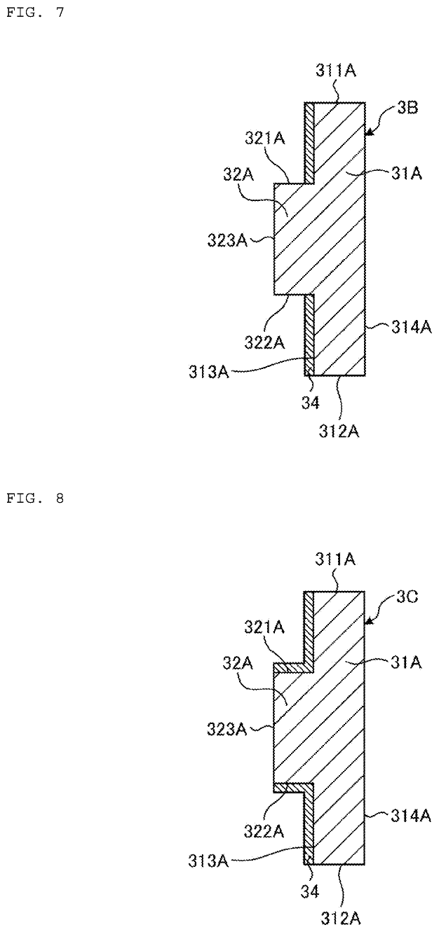

Next, a second modification will be described. FIG. 8 is a sectional view showing a positive electrode terminal according to the second modification. In the positive electrode terminal 3C according to the second modification, the anodic oxide coating 34 is provided on the front surface 313A of the main body portion 31A and the upper surface 321A and the lower surface 322A of the protrusion 32A.

With such a configuration, the inner wall 222A of the side portion 211A can be disposed close to the protrusion 32A of the positive electrode terminal 3A and hence, the opening 220A can be made smaller, whereby the sealability of the opening 220A can be further enhanced.

### EXAMPLES

The present application is described below in further detail including with reference to Examples according to an embodiment.

### Example 1

Example 1 corresponds to the first embodiment.

### (Preparation of Battery Element Body)

A positive electrode active material layer containing lithium cobalt oxide as a positive electrode active material was applied onto an aluminum foil as a positive electrode current collector to prepare a positive electrode. A negative electrode active material layer containing a carbon material as a negative electrode active material was applied onto a copper foil as a negative electrode current collector to prepare a negative electrode. The positive electrode and the negative electrode were wound with a separator of a polyethylene microporous film interposed therebetween to prepare a battery element body. As the electrolytic solution, a solution obtained by dissolving 1 M LiPF₆ as an electrolyte in a solvent of EC/DMC=3/7 was used.

### (Production of Positive Electrode Terminal)

In Example 1, first, a positive electrode terminal was produced. Specifically, a clad material was produced by joining an aluminum material (A1050 material), a stainless steel material, and a nickel material. The thickness of the clad material is 250 μm. Next, a disk having a diameter of 9 mm was punched out from the clad material on a press. Thereafter, a hard alumite layer having an average thickness of 10 μm was formed on the surface of the aluminum material in the disk of the clad material. For formation of the hard alumite layer, an oxalic acid alumite bath which is a kind of hard alumite was used. The hard alumite layer was formed on an annular portion of the surface of the aluminum material excluding a circular portion having a diameter of 4 mm at the central portion. Note that the average thickness of the hard alumite layer is an average value of measured thicknesses obtained by measuring thicknesses at four locations of the hard alumite layer.

### (Production of Lid)

Next, a lid was produced. Specifically, a disk having a diameter of 12 mm was punched out from a stainless steel material (SUS316L: 17Cr-12Ni-2Mo-low C) on a press, and a circular hole having a diameter of 6 mm was formed in the central portion of the disk. In this manner, an annular lid was formed.

Then, the positive electrode terminal and the lid were joined with the center of the positive electrode terminal and the center of the lid coinciding with each other. Specifically, an adhesive layer made of polypropylene (PP) was provided on the hard alumite layer in the positive electrode terminal. The adhesive layer was brought into contact with the lid, and the positive electrode terminal, the lid, and the adhesive layer were heated to thermally weld the positive electrode terminal and the lid with the adhesive layer made of polypropylene interposed therebetween. The adhesive layer after heat welding has an average thickness of 30 μm.

### (Production of Battery A)

Next, a housing main body was produced. Specifically, a stainless steel material (SUS316L) was subjected to press drawing to form a housing main body having a diameter of 12 mm and a height of 5 mm. The housing main body has a bottom portion and a side portion as in the first embodiment.

Then, the negative electrode tab of the battery element was welded to the bottom portion of the housing main body, and the battery element was housed in the housing main body. The central portion in the radial direction of the aluminum material of the positive electrode terminal is a non-formation region where the hard alumite layer is not formed. The positive electrode tab of the battery element was welded to the aluminum surface of the non-formation region.

Further, after the electrolytic solution was dropped onto the battery element, the lid was joined to the housing main body by welding to seal the opening on the upper side of the housing main body with the lid. In this manner, a battery A according to Example 1 was produced.

### (Production of Battery B)

A battery B as a comparative example with respect to the battery A of Example 1 was produced. The battery B is different from the battery A in that a hard alumite layer is not formed and that an adhesive layer made of polypropylene has a thickness of 80 μm.

### (Test of Capacity Retention Ratio)

The battery A was left for 2 months in an environment at a temperature of 65° C. and a humidity of 90%. When the capacity retention ratio of the battery A after being left was confirmed, the battery A exhibited a capacity retention ratio as high as 83% on average. The 83% on average is an average value obtained by averaging the capacity retention ratios of the nine batteries A.

On the other hand, when the battery B was left for 2 months in an environment at a temperature of 65° C. and a humidity of 90%, the capacity retention ratio of the battery B was 41% on average. The 41% on average is an average value obtained by averaging the capacity retention ratios of the nine batteries B.

### DISCUSSION

It was found that a higher capacity retention ratio can be obtained in the battery A than in the battery B. This may be because the battery A has a hard alumite layer and a thinner adhesive layer than the battery B, whereby volatilization of the electrolytic solution to the outside of the housing and entry of moisture into the housing are suppressed. It has been confirmed that the thickness of the adhesive layer of the battery A is thinner than that of the battery B, but the battery A has no short circuit defect.

Note that the above results mean that in an actual environment, for example, a wearable device such as an earphone, a risk of causing a significant capacity decrease without waiting for an expected life is reduced.

### Example 2

Example 2 corresponds to the first embodiment.

### (Preparation of Battery Element Body)

A positive electrode active material layer containing lithium iron phosphate as a positive electrode active material was applied onto an aluminum foil as a positive electrode current collector to prepare a positive electrode. A negative electrode active material layer containing a carbon material as a negative electrode active material was applied onto a copper foil as a negative electrode current collector to prepare a negative electrode. The positive electrode and the negative electrode were wound with a separator of a polyethylene microporous film interposed therebetween to prepare a battery element body. As the electrolytic solution, a solution obtained by dissolving 1 M lithium bis(fluorosulfonyl)imide (LiFSI) as an electrolyte in a solvent of EC/DMC=3/7 was used.

### (Production of Positive Electrode Terminal)

In Example 2, first, a positive electrode terminal was produced. Specifically, a clad material was produced by joining an aluminum material (A1050 material), a stainless steel material, and a nickel material. The thickness of the clad material is 250 μm. Next, a disk having a diameter of 9 mm was punched out from the clad material on a press. Thereafter, a hard alumite layer having an average thickness of 20 μm was formed on the surface of the aluminum material in the disk of the clad material. For formation of the hard alumite layer, an oxalic acid alumite bath which is a kind of hard alumite was used. The hard alumite layer was formed on an annular portion of the surface of the aluminum material excluding a circular portion having a diameter of 4 mm at the central portion. Note that the average thickness of the hard alumite layer is an average value of measured thicknesses obtained by measuring thicknesses at four locations of the hard alumite layer.

### (Production of Lid)

Next, a lid was produced. Specifically, a disk having a diameter of 12 mm was punched out from a stainless steel material (SUS316L) on a press, and a circular hole having a diameter of 6 mm was formed in the central portion of the disk. In this manner, an annular lid was formed.

Then, the positive electrode terminal and the lid were joined with the center of the positive electrode terminal and the center of the lid coinciding with each other. Specifically, an adhesive layer made of an epoxy resin was provided on the hard alumite layer in the positive electrode terminal. The adhesive layer was brought into contact with the lid, and the positive electrode terminal, the lid, and the adhesive layer were heated to join the positive electrode terminal and the lid with the adhesive layer made of an epoxy resin interposed therebetween. The thickness of the adhesive layer after joining was 0 to 8 μm.

### (Production of Battery C)

Next, a housing main body was produced. Specifically, a stainless steel material (SUS316L) was subjected to press drawing to form a housing main body having a diameter of 12 mm and a height of 5 mm. The housing main body has a bottom portion and a side portion as in the first embodiment.

Then, the negative electrode tab of the battery element was welded to the bottom portion of the housing main body, and the battery element was housed in the housing main body. The central portion in the radial direction of the aluminum material of the positive electrode terminal is a non-formation region where the hard alumite layer is not formed. The positive electrode tab of the battery element was welded to the aluminum surface of the non-formation region.

Further, after the electrolytic solution was dropped onto the battery element, the lid was joined to the housing main body by welding to seal the opening on the upper side of the housing main body with the lid. In this manner, a battery C according to Example 2 was produced.

### (Production of Battery D)

A battery D as a comparative example with respect to the battery C of Example 2 was produced. The battery D is different from the battery C in that a hard alumite layer is not formed and that an adhesive layer made of an epoxy resin has a thickness of 80 μm.

### (Test of Capacity Retention Ratio)

The battery C was left for 1 month in an environment at a temperature of 85° C. and a humidity of 90%. When the capacity retention ratio of the battery C after being left was confirmed, the battery C exhibited a capacity retention ratio as high as 96% on average. The 96% on average is an average value obtained by averaging the capacity retention ratios of the nine batteries C.

On the other hand, when the battery D was left for 1 month in an environment at a temperature of 85° C. and a humidity of 90%, the capacity retention ratio of the battery D was 28% on average. The 28% on average is an average value obtained by averaging the capacity retention ratios of the nine batteries D.

### DISCUSSION

It was found that a higher capacity retention ratio can be obtained in the battery C than in the battery D. This may be because the battery C has a hard alumite layer and a thinner adhesive layer than the battery D, whereby volatilization of the electrolytic solution to the outside of the housing and entry of moisture into the housing are suppressed. It has been confirmed that the thickness of the adhesive layer of the battery C is thinner than that of the battery D, but the battery C has no short circuit defect.

### Example 3

Example 3 corresponds to the second embodiment.

### (Preparation of Battery Element Body)

A positive electrode active material layer containing lithium cobalt oxide as a positive electrode active material was applied onto an aluminum foil as a positive electrode current collector to prepare a positive electrode. A negative electrode active material layer containing a carbon material as a negative electrode active material was applied onto a copper foil as a negative electrode current collector to prepare a negative electrode. The positive electrode and the negative electrode were wound with a separator of a polyethylene microporous film interposed therebetween to prepare a battery element body. As the electrolytic solution, a solution obtained by dissolving 1 M LiPF₆ as an electrolyte in a solvent of EC/DMC=3/7 was used.

### (Production of Positive Electrode Terminal)

The positive electrode terminal of Example 3 was a positive electrode terminal having the same shape as that of the second embodiment. The material of the positive electrode terminal is an aluminum material (A5052 material). In addition, as in the second embodiment, a hard alumite layer having an average thickness of 30 μm was formed on the upper surface, the lower surface, and the front surface of the main body portion of the positive electrode terminal and the upper surface and the lower surface of the protrusion. For formation of the hard alumite layer, an oxalic acid alumite bath which is a kind of hard alumite was used. Note that the average thickness of the hard alumite layer is an average value of measured thicknesses obtained by measuring thicknesses at four locations of the hard alumite layer.

### (Housing)

As in the second embodiment, the housing has a housing main body and a lid, and houses the battery element body. The material of the housing is a stainless steel material.

### (Production of Battery E)

An adhesive layer made of an epoxy resin was provided on the hard alumite layer formed on the front surface of the main body portion of the positive electrode terminal. The protrusion of the positive electrode terminal was inserted into the opening of the housing main body, and the main body portion of the positive electrode terminal was joined to the edge portion of the opening with an adhesive layer interposed therebetween. The battery element body was housed in the housing main body, and the positive electrode tab of the battery element body was welded to the front surface of the protrusion of the positive electrode terminal. The negative electrode tab was welded to the bottom portion of the housing main body. Then, the lid was joined to the housing main body by seam welding to produce a battery E.

### (Production of Battery F)

A battery F as a comparative example with respect to the battery E of Example 3 was produced. The battery F is the secondary battery of US Patent Application Laid-Open No. 2019/0341587. The battery F includes the rivet serving as the positive electrode terminal. The rivet includes a plate portion and a pin protruding from the plate portion. After the pin is inserted into the through hole of the gasket, the rivet is crimped onto the gasket by deformation due to crushing the tip portion of the pin. The rivet, the gasket, and the battery element body are housed in the housing.

### (Test of Capacity Retention Ratio)

The battery E was left for 2 months in an environment at a temperature of 70° C. and a humidity of 95%. When the capacity retention ratio of the battery E after being left was confirmed, the battery E exhibited a capacity retention ratio as high as 90% on average. The 90% or more on average is a value obtained by averaging the capacity retention ratios of the nine batteries E.

On the other hand, when the battery F was left for 2 months in an environment at a temperature of 70° C. and a humidity of 95%, the capacity retention ratio of the battery F was equivalent to that of the battery E.

### (Battery Capacity Test)

With respect to the battery E of Example 3, the rivet, the gasket, and the battery element body of the battery F are housed inside the housing. On the other hand, the electronic element body of Example 3 is disposed outside the housing. Thus, since the electronic element body of the battery E of Example 3 is larger than the battery element body of the battery F according to US Patent Application Laid-Open No. 2019/0341587, the battery capacity of the battery E of Example 3 was 7% larger than the battery capacity of the battery F according to US Patent Application Laid-Open No. 2019/0341587.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A battery comprising:
a battery element body including a positive electrode, a negative electrode, and a separator disposed between the positive electrode and the negative electrode;
a housing that houses the battery element body and has an opening;
a positive electrode terminal that covers the opening and is disposed outside the housing; and
an adhesive layer that joins the housing and the positive electrode terminal,
the positive electrode and the positive electrode terminal being electrically connected, and
the positive electrode terminal having an anodic oxide coating at a portion facing the adhesive layer.

2. The battery according to claim 1, having an anodic oxide coating on a side surface of the positive electrode terminal.

3. The battery according to claim 1, wherein the positive electrode terminal has a protrusion, and the protrusion and the positive electrode are electrically connected.

4. The battery according to claim 1, wherein an anodic oxide coating is provided at a portion where the housing and the positive electrode terminal face each other.

5. The battery according to claim 1, wherein the anodic oxide coating has a thickness of 2 μm or more and 100 μm or less.

6. The battery according to claim 5, wherein the anodic oxide coating has a thickness of 10 μm or more and 50 μm or less.

7. The battery according to claim 1, wherein the positive electrode terminal comprises at least one of aluminum, an aluminum alloy, or a clad material containing aluminum.

8. The battery according to claim 1, wherein the positive electrode terminal contains 93% by mass or more of Al.

9. The battery according to claim 1, wherein the positive electrode terminal contains 93% by mass or more of Al and at least one of Fe, Cu, Zn, or Mn.

10. The battery according to claim 9, wherein the positive electrode terminal contains less than 2% by mass of Si.

11. The battery according to claim 1, wherein the adhesive layer has a thickness of 5 μm or more and 200 μm or less.

12. The battery according to claim 1, wherein an average distance between the housing facing the anodic oxide coating and the anodic oxide coating in the positive electrode terminal is more than 0 μm and 30 μm or less.

13. The battery according to claim 1, wherein the anodic oxide coating is alumite.

14. The battery according to claim 1, wherein the housing comprises Fe, Ni, stainless steel, Cu, or a material obtained by subjecting Fe, Ni, stainless steel, or Cu to Ni plating.

15. The battery according to claim 1, wherein the anodic oxide coating has a Vickers hardness of HV300 or more.

16. The battery according to claim 1, wherein the adhesive layer comprises a polyolefin-based resin.

17. The battery according to claim 1, wherein the adhesive layer comprises an epoxy resin.

18. The battery according to claim 1, wherein the positive electrode and the positive electrode terminal are connected with a positive electrode tab interposed between the positive electrode and the positive electrode terminal.
